(19) United States
(12) Patent Application Publication
(10) Pub. No.: US 2005/0186856 A1
(43) Pub. Date: Aug. 25, 2005

(54) Connecting plate of a multi-layers IC board

(76) Inventor: Wen-Ling Lo, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/780,652

(22) Filed: Feb. 19, 2004

(51) Int. Cl. H01R 13/502

(52) U.S. Cl. 439/701

(57) ABSTRACT

The invention relates to a connecting plate of a multi-layers IC board, which includes the connecting plate being provided one end with an engaging step to connect with another engaging step of another connecting plate for shortening the length of the assembly. And the assembled plate can be used on a smaller multi-layers IC board that can provide a lighter and smaller product for being used effectively.

### FIELD OF THE INVENTION

The present invention relates to an improvement of connecting plate of a multi-layers IC board, which connects with each other and has a shorter length to facilitate application of product.

### BACKGROUND OF THE INVENTION

It is known that many new invention of technology is designed to be lighter and smaller for easy carriage and use. Hence, multilayers IC board has been developed for application. The multi-layers IC board should be engaged with connecting plate for working and the conventional connecting plates are always connected with each other by the structure, as shown in FIGS. 1 and 2. There are two connecting plates (1), (2), each of which is provided with a relating extended portion (11), (12) having respective inversed hook for matching engagement. A screw (3) is also provided to screw up two plates together. The length of this known assembly is still somehow long and can be improved.

### SUMMARY OF THE INVENTION

The present invention is to provide a connecting plate of a multi-layers IC board to shorten the connecting length for using on a smaller IC board. And the engagement of two connecting plates is very easy and secure. Now, accompanying with the following drawings, the character of the present invention will be described here and after.

### BRIEF DESCRIPTION OF THE DRAWINGS

FIG. 1 is an exploded perspective view showing the conventional connecting plates.

FIG. 2 is an assembled perspective view of FIG. 1.

FIG. 3 is an exploded perspective view showing the connecting plates of a multi-layers IC boards according to the present invention.

FIG. 4 is an assembled plan view of FIG. 3.

FIG. 5 is a front plan view of FIG. 4.

FIG. 6 is a front plan view of FIG. 2.

FIG. 7 is a perspective view showing the connecting plate being applied of a multi-layers IC board.

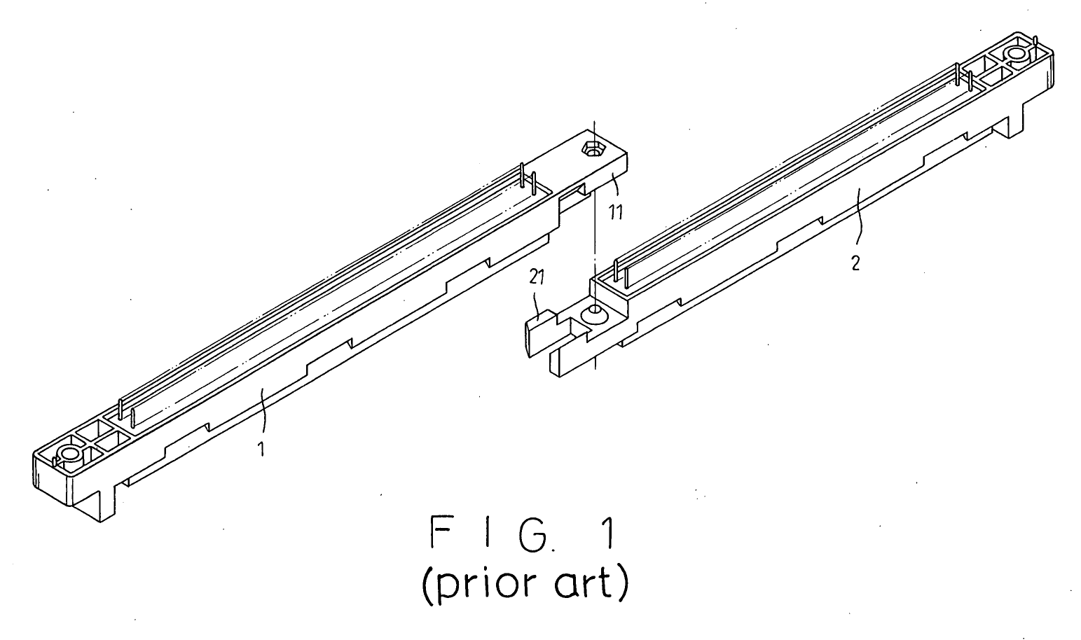

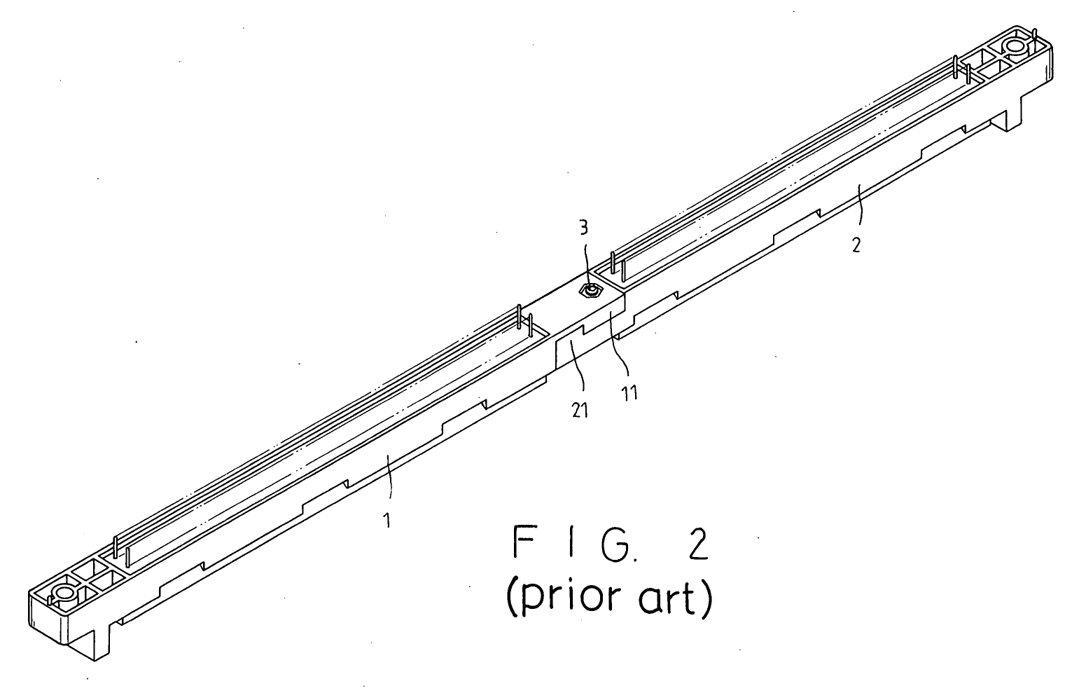

### DETAILED DESCRIPTION OF THE PREFERRED EMBODIMENT

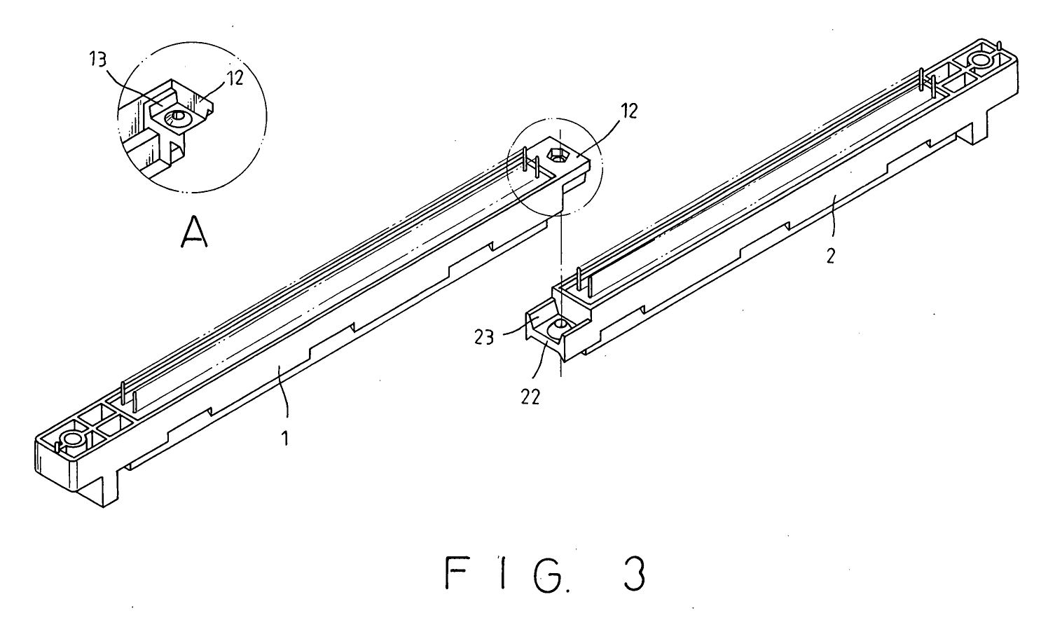

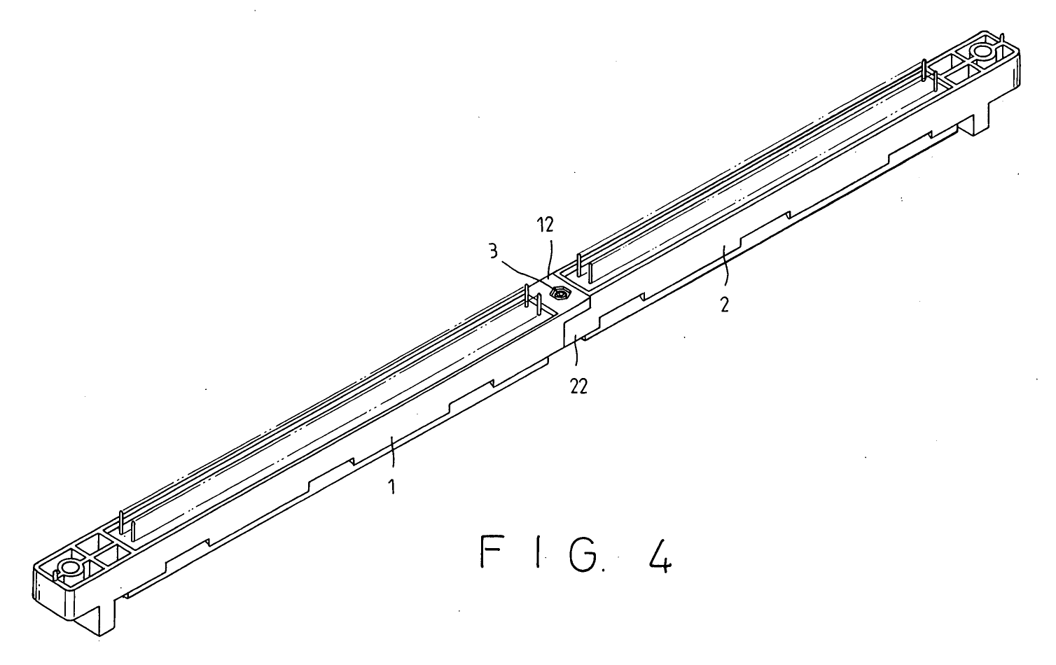

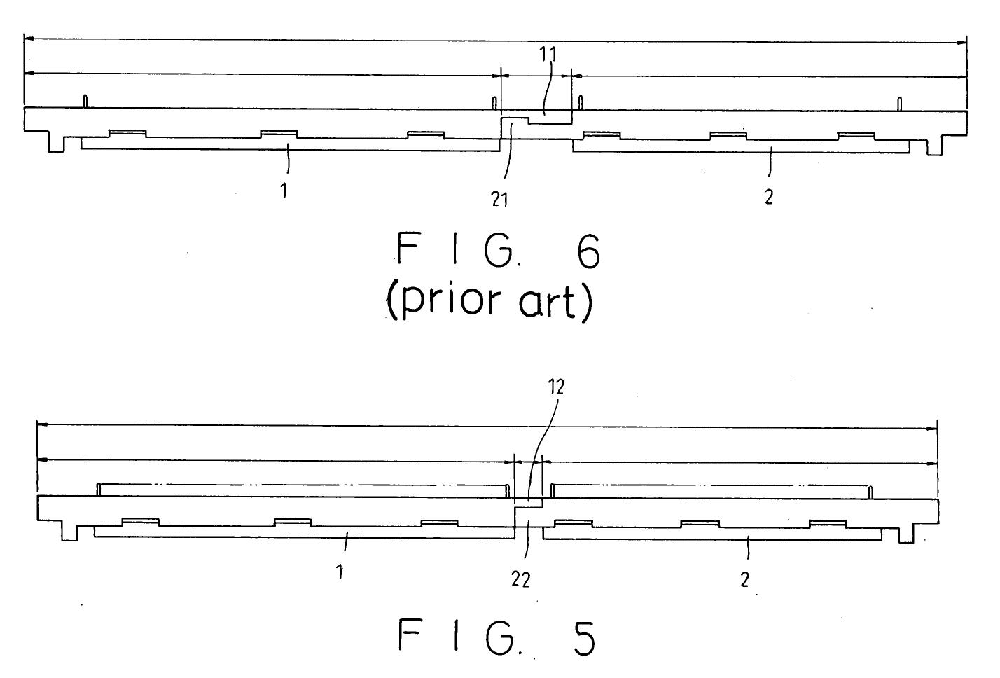

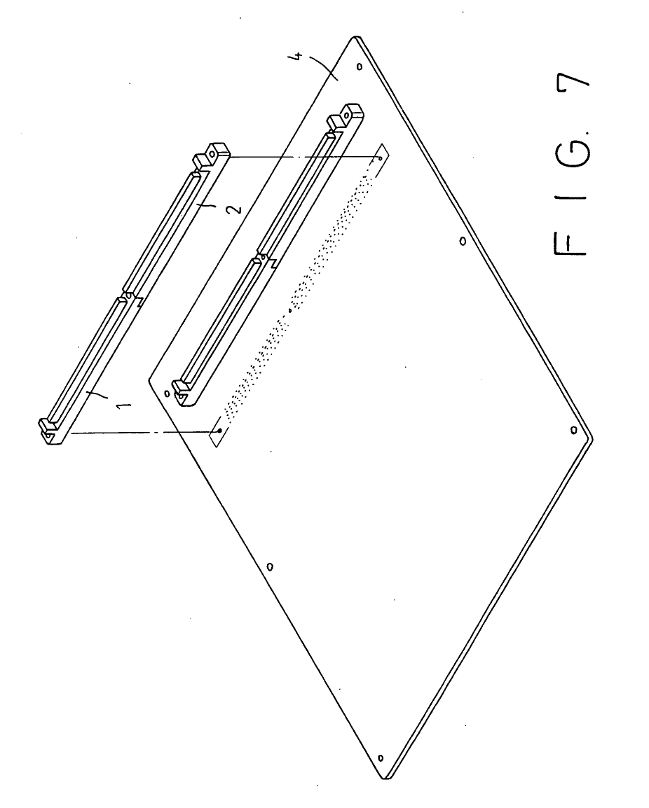

Referring to FIGS. 3 and 4, the present invention is to provide the connecting plates (1), (2) having a relating engaging step (12), (22), wherein the engaging step (12) has two bottom sides with inclined faces (13), as shown in FIG. 3A, and the engaging step (22) has two respective sides with relating inclined surfaces (23). Hence, two engaging step (12), (22) can be easily connected together firmly. As the screw (3) is screwed, the engagement will be secure certainly. Since the engaging step is shorter than the extended portion of a prior art, the assembled length (FIG. 5) of the present invention is accordingly shorter than the length of the conventional one (FIG. 6). So the present invention can be facilitated for applying on a new product, such as shown in FIG. 7 and is effective to shorten the assembled volume of the goods.

1. A connecting plate of a multi-layers IC board including the connecting plate being provided one end with an engaging step having bottom inclined sides to connect with another engaging step having two inclined sides of another connecting plate for shortening the length of the assembly.
